(19) United States
(12) Patent Application Publication
(10) Pub. No.: US 2004/0144472 A1
(43) Pub. Date: Jul. 29, 2004

(54) Process for manufacturing laminated plastic products

(75) Inventor: Kevin Eugene Huntley Cowie, Mississauga (CA)

Correspondence Address: George W. Moxon II, Brouse McDowell, 500 First National Tower, 106 S. Main Street, Akron, OH, 44308-1417, US

(73) Assignee: G & D Cardtech, Inc.

(21) Appl. No.: 10/350,854

(22) Filed: Jan. 24, 2003

(51) Int. Cl. B32B 31/00; G06K 5/00

(52) U.S. Cl. 156/64; 156/219; 235/380

(57) ABSTRACT

A method of and system for manufacturing discrete printed laminated plastic products from sheet stock by employing the steps of providing a programmed computer, creating a master template that defines the position and other attributes of the graphics and/or text to be printed on the plastic products, inputting into the computer information concerning the type of product, information to be printed, and entering the information concerning the master template into the computer, providing a sheet stock and printing graphics and/or text in discrete areas of the sheet stock, assigning a unique identity to each discrete printed area and to each sheet containing a plurality of discrete areas, manufacturing the plastic products by laminating said sheet stock to form a laminated plastic stock material having discrete printed areas, cutting and/or punching said laminated plastic stock material to form discrete plastic products from said discrete printed areas, finishing the products to enable them to function for their intended purpose, personalizing the plastic products, inspecting said discrete plastic products and eliminating those that do not meet manufacturing standards, entering information concerning the inspection results into said programmed computer, re-ordering and manufacturing any rejected discrete printed laminated plastic products, if necessary, collating the re-ordered products with any additional manufacturing, finishing, and/or personalization steps, collecting said discrete printed laminated plastic products, and collating the plastic products with mailing materials for mailing to customers.

### BACKGROUND OF THE INVENTION

The present invention is directed to an improved process for manufacturing high-quality laminated plastic products, such as credit cards, license cards, bookmarks, keepsake photo cards, shopping cards, pre-paid cards, retail store cards, financial cards, insurance cards, travel cards, transit passes, and personal identification cards. This improved process facilitates the manufacture of products that have individually unique appearance or a similar appearance among a very low quantity of products.

A typical process for manufacturing high-quality laminated plastic products involves the following steps:

1. Preparation of the art work to be displayed on the plastic product,

2. Conducting the prepress steps of proofing the art work and preparing, as necessary, the films, plates, and screens used to print the art work,

3. Printing on one or more, inner or outer layer or layers of the plastic which is to be laminated to form the product and which printing will provide the graphics on the product,

4. Collating the sheets to be assembled into the plastic product, which step can and may be done as preassemblies and by a variety of processes,

5. Shear cutting and punching the laminated assembly to produce the individual cards,

6. Inspecting the laminated plastic cards to assure that they have met the manufacturing requirements, and

7. Finishing the plastic products by providing as necessary any additional features on the product that are necessitated by the function of the card, such as for a credit card, an identification card, a transit pass, etc., which finishing step or steps may include adding the following to the card:

A. A hologram,

B. A signature panel,

C. A magnetic strip, which will hold electronic information on the account, such as for example, details and pin number of a bank account,

D. An embedded computer chip,

E. Personalization of the product by embossing characters on the product, encoding the electronic information, engraving characters into the card, thermal printing bar codes, numbers, photo ID's, and the like, initializing the embedded computer chip, and adding a card activation label, which are often used to confirm correct receipt of a new or replacement credit card.

After the plastic product is manufactured, it is further processed for delivery to the customer, a process referred to as the fulfillment step, which includes the personalization of a pre-printed carrier to match the details of, for example, a credit card customer, matching the card and the personalized carrier, insertion of the card and carrier, plus any other mailing materials, into an envelope or other appropriate container, and mailing or otherwise distributing the plastic product.

The manufacture of such laminated plastic products generally is known as are certain specific steps in the process. For example, U.S. Pat. No. 3,461,581 to Hoffman discloses a plastic card and method of making the cards, including inserting of the individual data on the cards by process which provides great accuracy and speed. U.S. Pat. No. 5,145,548 to Yamamoto discloses a laminating device for use in laminating a continuous ID card or identification card. U.S. Pat. No. 5,951,810 to Tarantino discloses a method for mounting an electronic module in a card body. U.S. Pat. No. 6,264,774 to Lenz et al. teaches a card laminator having improved control of the lamination step.

Typically these processes for manufacturing laminated plastic products have focused on extremely repetitive graphical composition and layout for mass-printed products. Once the composition of the plastic product, including the graphics, is fixed, then they are produced in great quantities with little differentiation. To accommodate the fact that there will be quality rejects, extra copies or spares are produced. Usually a number is chosen, based upon experience, so that there will be more extras than quality rejects. When an error in the manufacturing process occurs and there are more errors than extras, it becomes necessary to hold up an order until the correct number of erroneously manufactured products is manufactured. In each case, there is waste because of the additional products that need to be manufactured or the delays in the manufacturing process due the need to hold an order to produce extra products.

### SUMMARY OF THE INVENTION

The process of the present invention is the result of the realization that it is possible to produce individually unique laminated plastic products without incurring the time and cost associated with having a skilled human operator composes the graphical elements each time. The resulting products must meet the strict quality and dimensional specifications of Visa, MasterCard, and other major card issuers and associations, as well as the necessary specifications for other laminated plastic products, but the products can be delivered within the turnaround times expected for normal card personalization; and the total cost of production can be competitive with traditional approaches to card manufacturing and personalization

Management of product orders, graphical composition, production flow, and reject processing is all accomplished by a process which employs a programmed computer, in combination with identification codes, that processes orders, matches orders to images for printing, optimizes production groups, composes images for printing, tracks production steps, and records units produced and units rejected, all in a continuous production cycle. The automation of graphical composition and subsequent production steps results in a rapid-turnaround continuous-process production cycle, which allows the elimination of scrap allowances. Instead of producing excess volume in anticipation of scrap, quality rejects are simply entered in the next rapid-turnaround production cycle.

This management is made possible by the batch and sheet identification marks which may also yield benefits to traditional card production to ensure proper matching of obverse and reverse sheets, and tracking of production batches. Further, the rapid-turnaround process allows for the manufacturing of mass-printed products on-demand, rather than for inventory storage. Automated product tracking systems allows for the finishing of and applying personalization to products, as well as printing carriers for products, when there is no prior knowledge of the sequential order of the products.

The process of the present invention employs the typical steps of manufacturing the laminated plastic products, but additionally employs a programmed computer which is used to generate the identification marks and in combination with the identification marks to manage the process to define the position and attributes of each image, graphic, or text element that may appear on a face of the product. By this process, when an individual product or products are rejected as part of quality review process, they can be replaced subsequently and integrated into the production run or collated with other manufacturing steps because the program notes the products that are rejected and automatically can begin the process to manufacture another which will be individually produced.

### BRIEF DESCRIPTION OF THE DRAWINGS

For a complete understanding of the objects, techniques and structure of the invention, reference should be made to the following detailed description and accompanying drawings, wherein:

FIG. 1 shows printed sheet of the front or obverse side of credit cards;

FIG. 2 shows a printed sheet of reverse side of the of the credit cards shown in FIG. 1 and that will be joined with the sheet of FIG. 1;

FIG. 3 shows an exploded view of a bank credit card before assembly and lamination;

FIG. 4 shows the front side of a printed sheet of individually unique credit cards showing batch and sheet identification codes;

FIG. 5 shows the reverse side of the printed sheet of individually unique credit cards shown in FIG. 3 and showing the card identification codes;

FIG. 6 shows the reverse side of a single credit card showing the card identification code; and

FIG. 7 is a flow chart of the preferred card manufacturing process of the present invention.

### DETAILED DESCRIPTION OF THE INVENTION

The process of the present invention employs most of the typical steps of manufacturing laminated plastic products, in combination with a programmed computer which generates the identification marks, uses the marks in managing the process, and stores the information which is used to define the position and attributes of each image, graphic, or text element that may appear on a face (obverse or reverse) of the product and receives information concerning the type of product, the information to be printed, and the results of the quality inspection. By this process, when an individual product or products are rejected as part of quality review process, they can be replaced subsequently and integrated into the production run or collated with other manufacturing steps because the program notes the products that are rejected and automatically can begin the process to manufacture another which will be individually produced.

The process and system of the present invention facilitates the manufacture of high-quality laminated plastic products, such as credit cards, and allows the manufacturer to deliver the following benefits without losing efficiencies and economies of scale associated with mass production:

1. Offer their customers a highly individualized product appearance;

2. More accurately meet the demand for any particular product appearance; and

3. Ability to produce very low quantities or single quantities of any particular product.

The present process delivers a great variety of product appearances at near the cost of mass-produced products with highly variable demand cycles and no required minimum order quantities for any given appearance. Thus, the process offers a flexibility not found in prior processes for making functional cards or products. For the purpose of this application, the term “functional card” or “functional products” is intended to include credit cards, as well as debit cards, ATM cards, shopping cards, loyalty cards, gift cards, purchase tracking cards, pre-paid cards, security cards, identification cards, telephone cards, transit passes, traveling cards, personal identification cards, keepsake cards, collection cards, and the like, including cards having functional means such as holograms, signature panels or pads, stickers, punch-out areas, magnetic strips, photographic identification strips, contact chips, contactless chips, card company identifier(s), and the like for identification, validation, and authentication. For the purpose of explaining the process of the present invention, the manufacture of a credit card, such as a bank credit card, will be employed throughout the discussion. But, it will be appreciated that the process can be applied to other laminated plastic products with appropriate variation.

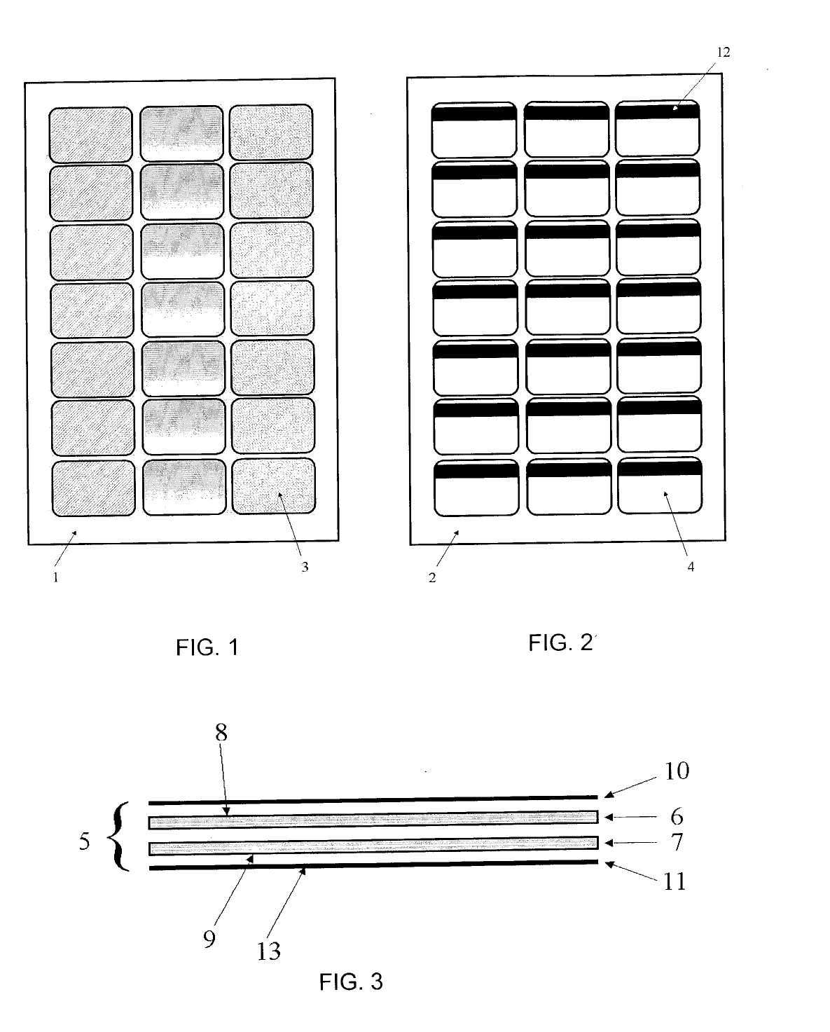

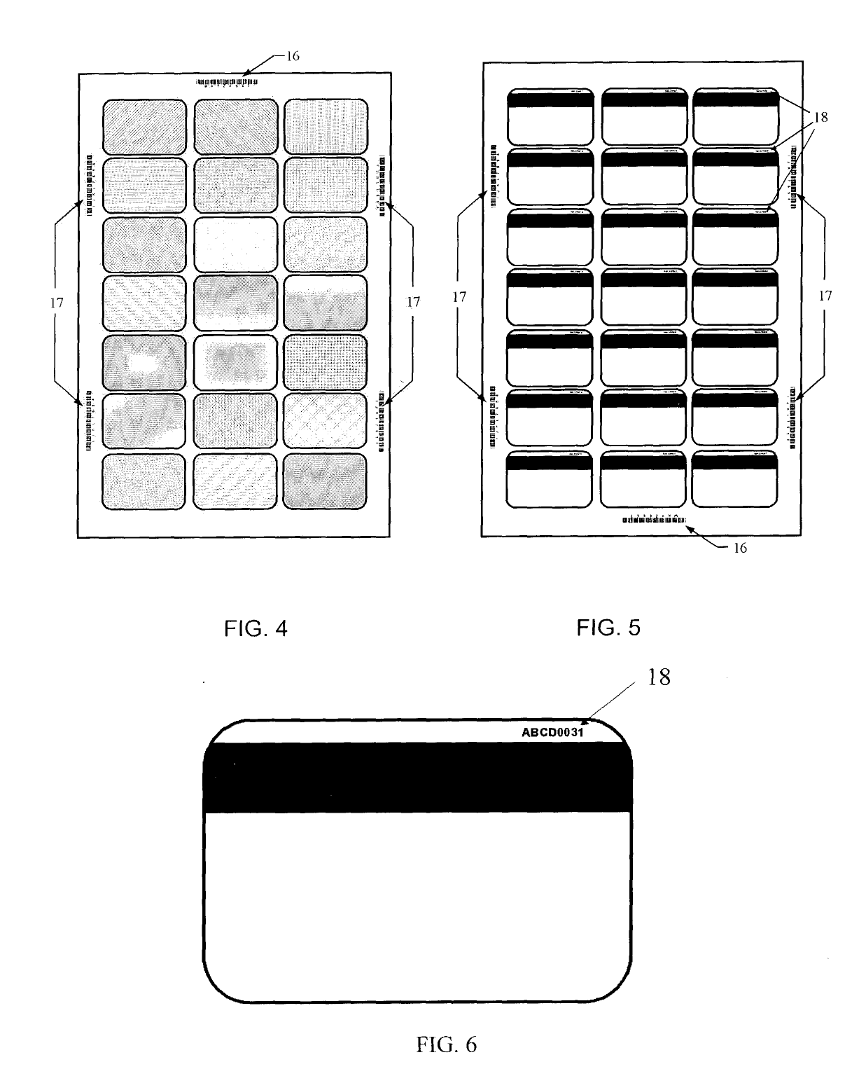

In a typical manufacturing process the cards are printed in rows and columns on large sheets using, e.g., production presses so that there are discrete areas on the sheets having printing thereon. The printing or image composition and layout refer to the graphics work or text which composes the discrete or individual images, which are placed (typically multiple copies of the same image) in the rows and columns. In this process, there may be a small degree of variability on a sheet design, whereby images are differentiated from column to column; however, each sheet in a production run is printed with this identical image layout. The typical layout of front and back sheets for credit cards is illustrated in FIGS. 1 and 2 where FIG. 1 illustrates the front or obverse side of a credit card, while FIG. 2 illustrates the reverse side. In this case, each front sheet 1 is undifferentiated from other front sheets, and each back sheet 2 is undifferentiated from other back sheets. Further, although a sheet of 3 cards by 7 cards is shown, the invention can be employed for other combinations of cards. Where the plastic product has printing on what is the front 3 and back 4 of the finished product, this can be done by the front being one printed sheet and the back being a second printed sheet. These sheets are then joined together by a laminating process. From a different view, as shown in FIG. 3, the card 5 may comprise obverse and reverse card sections 6 and 7 to which printing or graphics are applied at 8 and 9, respectively, and over which are laminated protective layers 10 and 11. A magnetic strip, such as magnetic strip 12 in FIG. 2, can be affixed to surface 13 of card 5, as well as other appropriate identification means or devices.

As can be appreciated, the process is not limited to any number of layers that make up the card. As shown in FIG. 3, the card is made up of four layers. A minimum number of layers would be one where that layer is printed on each side to produce the appropriate functionality. For convenience, there are usually at least two layers to allow each to be printed and then the two layers are joined together to create the card. Further, the process is not limited to the use of discrete cut sheets of materials to produce cards. The process could be applied to the use of continuous rolls of material. But, for purposes of explaining the invention, the process will be discussed in terms of sheets of materials.

The image on the front or back of a product may actually be composed of multiple component images superimposed upon each other in specific locations, at specific sizes, and with other specific attributes. For example, the front of a MasterCard credit card includes a minimum of two images: the main background image, and the MasterCard logo. It can also include separate images for card issuer logos and other text and graphics. Some cards may have many other component images in a much more complex layout. The back of the card may be more complex than the front, incorporating multiple areas for written text, magnetic stripe alignment marks, the manufacturing batch code, the card style code, the card issuer logo, one or more financial network logos, and other text or graphics for customer service numbers, etc.

In traditional processes, the front and back of each product is laid out by a skilled graphics operator, as a single consolidated image. In addition, trim marks, cutting marks, and machine alignment marks are printed on the sheet to facilitate production steps subsequent to initial printing. This layout is then used to create a printing plate through a photo-lithographic process or a digital process, or it is transferred in electronic form directly to a digital press. The lithographic or digital press can then print one or many copies of this master layout. The key attributes of traditional processes is that all sheets in a batch are identical to each other for mass production, and are based upon images that have been composed by a skilled human graphics operator.

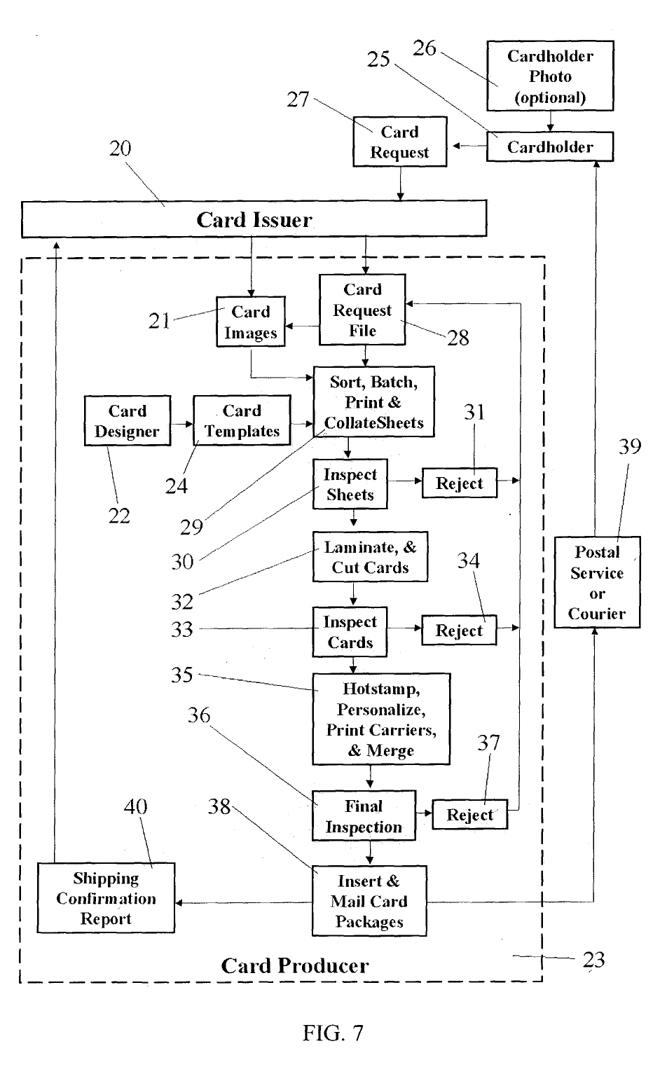

The process of the present invention automates the entire process of image composition and layout of the images and marks on large format press sheets. In the best mode currently employed by the inventor software performs the automation in the following way, as illustrated in the flow chart in FIG. 7:

a. A Card Issuer 20 may provide a Card Producer 23 with pre-approved Card Images 21. A Card Designer 22 uses these card images, if available, in combination with industry-approved card specifications, to create one or more Card Templates 24. The card template defines the position and other attributes of each potential image, graphic, or text element that may appear on one face of the product which may be considered the obverse face. An associated template is composed for the other face of the product, which may be considered the reverse face. These templates are developed using software that is compatible with the digital press that will ultimately print the images. It is preferred that the software used is QuarkXpress, a standard graphics software package, available from Quark, Inc. and Yours Truly Designer, a software extension to QuarkXpress, developed by the Indigo Division of Hewlett Packard Company. The procedures to be followed to compose these images in a form compatible with the HP Indigo Digital Press are set forth in the documentation and training materials available from HP Indigo, and are incorporated herein by reference.

b. A Cardholder 25 submits a Card Request 27 to the Card Issuer 20. This request may or may not incorporate a photo or other image provided by the cardholder to be printed on the card. The Card Issuer 20 combines requests from many cardholders and provides a Card Request File 28 to the Card Producer 23. The details in the Card Request File include the main background image to be used, the type of product (e.g. bookmark or credit card, Visa or MasterCard, Gold or Platinum, etc.), and information to be printed on the reverse face of the product. For some elements, the file provides a simple reference to a database of Card Images 21 (e.g. obverse image #1592-A); for others it may provide the actual content to be included (e.g. “For toll-free customer service call 1-800-555-5555”, or “2002061909241895.jpg” as an imbedded graphics file as provided by the cardholder).

c. The Card Request File 28 is processed by a program that interprets the attributes of the product for each card request, and determines which elements are to be incorporated into that particular product. Products with common manufacturing attributes are grouped together and separated from other groups with different manufacturing attributes. If the file incorporates streaming image data embedded within the file, this data is extracted to represent the image to be imposed. If only a reference code is provided, the program automatically retrieves the corresponding information or image from the Card Image database 21 based on the reference code. The program then performs calculations to determine the appropriate relative coordinates for each digital image or text element in the composite card template. The program also computes the appropriate relative coordinates for each composite card image in the final sheet layout. The program performs this process for each product request, defining the position of each element in a product and each product on a sheet. In this way, products and sheets are individually composed. Each product on a sheet is unique, and each printed sheet is unique in a production run.

d. In addition to elements composed to create a unique appearance, the software computes and assigns a unique identity to each product, and prints a code representing that identity on each product, such as that shown in FIGS. 5 and 6, and discussed herein. Furthermore, the process of assembling product images into sheet rows and columns includes the creation of a unique code for each sheet and each production batch, where a production batch is defined as a group of cards in the same production run that exhibit common manufacturing attributes. These codes are printed on each sheet for identification and batch separation in subsequent production steps. As shown in FIGS. 4, 5, and 6, identification codes (or ID codes) can be provided on the obverse sheet and reverse sheet shown in FIGS. 4 and 5 for the batch 16, the sheet 17, and the card 18.

e. Once the card requests have been sorted, grouped, and have been translated to individual card images and codes, they are printed on, for example, digital press 29. The normal procedures for proper operation of the digital press, which are provided by the manufacturer, are followed. Following digital printing, the sheets may also have additional text or graphics printed on them using a traditional offset or silkscreen printing process. After printing, the sheets are collated to attach each obverse or front sheet with its corresponding reverse sheet. The collator is equipped with two bar code readers to verify the sheet bar code 17 on the front sheet matches the sheet bar code 17 on the reverse sheet. If the bar code readers detect front sheet and reverse sheet bar codes that match each other, they send a signal to the collation computer to allow the collator to proceed with tack welding the front sheet with the reverse sheet. If the bar code readers do not detect this match, the sheets cannot be tacked together and the operator must resolve the conflict by determining and correcting the reason for the mismatch, such as a defective or poorly printed bar code, misalignment of the material, improper oriented sheets, or other problems. The operator will then locate the proper matching sheet and proceed with collation, or verifying a proper match manually and override the bar code readers (which requires a supervisor's authorization, access badge, or override code), or reject the mismatched sheets. Assuming a match, the sheets are then tacked together in preparation for subsequent lamination. At this point, each sheet may also be inspected 30 for gross flaws or errors. For any sheets that are rejected 31 during this process the sheet bar code 17 is recorded and the sheet is set aside for destruction. The cards on these sheets must be subsequently reproduced as “remakes”, as will be discussed further herein.

f. After the sheets have been collated, front and back overlay films 10 and 11 are applied to the sheets, they are laminated and cut into individual cards 32. These overlay films may be applied manually in a manual tack welder. Subsequent to collation and application of the overlay films, the collated sheets are assembled into laminator books, the composition and assembly of which will depend upon the lamination system being used and in accordance with the vendor's instructions. Lamination is accomplished under heat and pressure to bond the layers together. Laminated sheets are then passed through a die cutter to punch out individual cards 32. The die cutter may be a manually operated machine or an automated machine that performs some or all of the following functions: feeds sheets, trims sheets, die cuts cards, collects individual cards, counts cards, and discards unused portions of sheets. The die cutter is equipped with a bar code reader to read the batch bar code 16 to identify when one production batch ends and another batch begins (indicated by a change in the batch bar code). At the end of each batch, when a new bar code is encountered, a signal is sent to the die-cutting machine to stop it and the cards from that batch and their status are collected together for subsequent production steps and their status is updated on the batch information sheet and the inventory tracking system. If the inventory tracking system verifies the card count the batch is permitted to proceed to the next step and the die cutting machine is then restarted to continue with the next batch in the batch group. If the card count is not verified, the batch is held until completion of the current batch group to determine if other cards from the batch are encountered. If so, these cards are reunited with the original collection and the count is re-verified. If not, then an investigation will be initiated to determine the location and disposition of the apparently missing cards.

g. Following die cutting, all cards are subject to a rigorous inspection 33 to assure product quality. Any cards that are rejected 34 during this process are set aside for subsequent reject processing, the process of which is described elsewhere in this document. Good cards are then hot stamped 35 as appropriate, with elements such as holograms, decorative foils, and signature panels being applied to the cards. This step is referred to as card finishing. The specific procedures to accomplish card finishing will depend upon the particular hot stamping equipment employed. The choice of the equipment is not critical and equipment is available from a number of hot stamping equipment vendors.

h. Finished cards are then personalized, have carriers printed, and are merged with those carriers 35. Personalization refers to the application of cardholder-specific information to the card, through encoding of magnetic stripes or smart chips, embossing of information, printing of additional information, or other means. The process of personalization, carrier printing, and merging is described in greater detail elsewhere in this document.

i. Following merging, cards and carriers are subject to a Final Inspection 36. Cards that fail this inspection are set aside for reject processing 37, described in detail elsewhere in this document.

j. Cards and carriers that pass final inspection are then inserted into envelopes, potentially with other inserts, and are prepared for induction into the mail stream or courier shipment 38. This preparation may include presorting for mail discounts, printing of mailing codes, application of postage, or other mail-related steps. The packages are then inducted into the mail stream or shipped via courier 39. Upon release of the packages to the transporter a Shipping Confirmation Report 40 is generated and sent to the card issuer to report the shipment.

When cards do not pass the quality inspection, it becomes necessary to process the rejects and remake them. This is noted in the reject processing discussed in connection with steps 31, 34, and 37. But, these steps are further understood in the context of the traditional manufacturing steps. The printing industry has a long standing history of producing more quantity than was ordered by a customer to allow for quality rejects and other scrap. Furthermore, this excess production is simply a rough estimate, and may result in an overrun or a shortfall of finished product. By industry norms, and within established ranges (e.g. 5% or 10%), overruns are billed to the customer even though they exceed the total quantity ordered, and shortfalls are not made up even though they are below the quantity required by the customer. The customer must consider this quantity range when placing orders, and accept the excess or shortage that may result. In addition, with traditional production processes, if the scrap rate is so high that the quantity of acceptable copies produced falls below the minimum allowable threshold, another dedicated batch must be produced to make up the difference.

In the best mode of production of the present invention, the process prints and manufactures only the exact quantity of each product ordered. Since each unit produced may be unique, manufacturing just a single extra copy of each product can result in a 100% increase in the production run, and it still offers no guarantee that at least one unit of each product will survive the entire production process.

The present process allows that any given production run will nearly always fail to complete the entire order placed by the customer. Quality inspection will inevitably reject some items from the production batch. These rejects are made up in a subsequent production run. Scrap is a fact of life in manufacturing processes, but the process allows for the replacement of production that is lost to scrap. The benefit of one-for-one printing is minimization of excess production and reduction of costs.

There are numerous opportunities to identify quality rejects throughout the production process, at both the sheet level and at the unit card level. Each time a sheet 30, a card 33, or a merged card and carrier 36 is identified as a quality reject it is separated from the rest of the production run. With the present process, each sheet and/or product has a unique identification code printed on it. Periodically throughout the production process, rejected sheets and/or products are collected and logged as rejects. Rejected sheets have their sheet codes logged by scanning the bar code or by manually entering the sheet code on a terminal. Rejected cards may be collected together and passed through the Datacard personalization machine using a special machine setup that only reads and records the unique ID code. The process to read the unique ID code is provided for this purpose, as will be explained hereinafter. The output file may then be imported into the control system to log those cards as rejects. Alternatively, rejected cards may be logged by having their unique ID codes manually entered on a terminal.

When sheets or cards are logged as rejects, the control system removes the associated requests from the current production run, identifies them as “remakes” and places them in the input queue to be combined with the next Card Request File 28 and produced as part of the next regular production run. Rejected cards or sheets may then be destroyed. Special runs are never scheduled to replace rejected products. The benefit of this process is to complete the production run in as little time as possible, minimizing turn-around time and accelerating distribution of the product in the marketplace.

It is preferred that the unique product identity is printed as a human- and machine-readable 8-character ID code (including a checksum digit) in a very small typeface between the edge of the magnetic stripe and the edge of the card. This typeface may be printed by the digital press of choice (the HP Indigo Press S2000) and may be read by existing optical character recognition (OCR) systems that may be integrated with the existing Datacard embossing and encoding equipment. This has been determined to be the best mode because of compatibility with printing and personalization equipment.

This individual identity is critical to the workflow in accordance with the present invention. Since each product has an appearance that is customized to a specific customer's preferences, that product must be identifiable at the personalization stage to ensure that the correct personalization data is applied to the product. It is also then matched to the correct letter, envelope, carrier, and other fulfillment items that are also customized for the end customer.

Alternate means for identifying and/or recording the unique product identity are as follows:

1. The use of a printed bar code or human-readable code in the area of the card back reserved for the credit card signature panel will allow the card to be scanned prior to applying the signature panel and encode the magnetic stripe with the unique product identity code. When personalizing the card, the code from the magnetic stripe can be used to perform a database lookup and apply the personalization data.

2. The use of special infrared-sensitive ink to print the unique product identity code in the area of the card back reserved for the credit card signature panel which would allow for the use of a high-intensity infrared light source to read the code through the opaque signature panel during the personalization process.

3. The use special infrared-sensitive ink to print the unique product identity code on the back side of one of the sheets of core stock, thereby encapsulating the code between the two sheets of core stock during lamination. This will allow for the use of a high-intensity infrared light source to read the code through the opaque core stock during the personalization process.

4. The use of a special ultra-violet ink to print the unique product identity code in an open area of the card obverse or reverse side. This allows for the use of an ultraviolet light source to read the code during the personalization process.

Personalization is a process that is most applicable to cards, but may also have applicability to other manufactured laminated plastic products. This process will be described in the context of card personalization, but may be extended to other products by adapting personalization machines to different physical formats. Personalization of cards refers to a number of steps used to apply customer-specific information to a card. It includes: encoding the magnetic stripe and/or smart chip; embossing the account number, valid dates, cardholder name, and security symbols; indent printing of account number and PIN information; printing variable text and graphics on the card face; and other steps that are less cardholder-specific. All of these steps are normally performed on a single machine that integrates a series of special-purpose modules to accomplish each step. Individual cards are carried through the machine and each operation is carried out in sequence.

Today's personalization machines are designed to have a stack of identical card “blanks” (i.e. with no personalization information applied to them) loaded into a hopper to feed the machine a supply of cards. A data file of personalization data is installed on the machine, and the cards are personalized in sequential order—the first data record is applied to the first card, the second record to the second card, et cetera. If a personalization operation is unsuccessful or a card is rejected, that data record is applied to the next card in sequence without detriment to the process.

The present process is such that each card is already “individualized” prior to arrival at the personalization machine. Each card is preprinted with the image selected by an individual customer and possibly with variable text and graphics. Ergo, it is not sufficient to simply assign personalization data to each card in sequence, or skip a card in the event of an unsuccessful operation. The process must ensure that each card receives personalization from one and only one specific data record.

In the preferred process of the present invention, the process allows for cards to be in an unspecified order when they are placed in the input hopper of the personalization equipment. During automated image composition and layout, the data record of each customer is assigned a unique code, which is also printed on the card image. At the personalization stage, the complete file of customer records that is associated with that production batch is installed on the machine. The cards from that batch are loaded into the input hopper—the order of the cards bears no relationship to the order of the records in the data file. An Optical Character Recognition (OCR) system may be integrated with a personalization machine to read codes that are printed on cards and perform a “read-lookup” to retrieve information for further personalization. Procedures for integration and operation of this OCR system are dependent upon the particular OCR system selected and it is operated in accordance with the vendor's recommended procedure. Cards are drawn from the input hopper one at a time and the code that that was preprinted on the card is read by this OCR system. This code is then used to perform a database lookup in the file of customer records. This lookup returns a record of customer personalization data, which is communicated to the various modules installed in the equipment to apply specific and individual magnetic stripe encoding, chip encoding, embossing, printing, tipping, stickers, and other personalization information to each card.

Alternate means for applying personalization data to cards are as follows:

1. Perform a first pass with the cards on the personalization machine to read the unique product identity code from each card back to discern the order of the cards and produce a data file that records this order. Use this data file as an index to re-sort the file of personalization data into the same order as the cards. Install this ordered personalization file on the personalization machine and perform a second pass with the cards to apply personalization data with a traditional sequential method.

2. Perform a first pass with the cards in a card sorter to organize them into the same order as the original personalization data file. Install this original personalization file on the personalization machine and perform a second pass with the cards to apply personalization data with a traditional sequential method.

3. Design the manufacturing process to ensure that the cards are in a specific sequential order, and that the data file follows the identical sequential order. In this case, personalization data may be applied to the cards with a traditional sequential method. Coordination and control of card sequence becomes critical in this process, because a single missing card will result in all subsequent cards in the entire batch having the incorrect personalization data applied to them.

In the case of processing 2-card accounts, a variation on the first alternate mode with the addition of a card buffer module was selected as the best mode for ensuring that both cards from a 2-card account are placed in contiguous order for subsequent merging onto a single card carrier (described later in this document). This is accomplished by using a card buffer on the personalization machine to hold one card from a 2-card account aside until the second card from that account is received, and then releasing the first card to place it in contiguous order with the second card. In this operation, because of a conflict in the personalization machine operating system between the database read-lookup and the use of the card buffer, the two functions cannot be used on one machine at the same time. Hence, the two-pass mode is used to discern card order and apply personalization data without using the database read-lookup function.

After they are manufactured, finished, and personalized, the laminated plastic products must be sent to the customers. To do so, products are often affixed to a carrier, which may be a letter-sized or legal-sized paper sheet, and which typically contains information for the customer who receives the product. A carrier may have 1, 2, or more products affixed to it. Carriers are typically folded and inserted into envelopes, possibly with other inserts, for mailing to end customers. As described above in traditional processes, the sequential order of a personalization input file normally controls the order of card personalization. Ergo, cards are also merged with their carriers in the same sequential order. This synchronicity is used to allow the carriers to be printed prior to card personalization, and subsequent merging incorporates a simple verification step to ensure that the card matches the carrier to which it is being merged.

Inline carrier printing on the personalization machine is also used, and it obviates this verification step because carriers are printed on the same machine that is doing the card personalization and carriers are printed on-demand as cards are personalized.

In the present process, it is preferred that the personalization machine be programmed to write an output file (or “audit file”) listing the order in which the cards were personalized. This output file is then used as an index of card order to use to re-sort the file of carrier print records, enabling the process to print carriers in the same sequential order as the cards. After the carriers are printed they are mounted on the merging machine and are processed in a traditional fashion using a simple verification step to ensure that the card matches the carrier to which it is being merged. Thus, the process of the present invention allows for even more individualization and personalization in the delivery or fulfillment part of the post manufacturing steps that need to be taken.

Alternately, printing carriers and merging cards to their respective carriers can be done using inline carrier printing in the same manner as traditional work and using the information passed to the carrier print module within the personalization machine. These carriers may be preprinted forms that have cardholder-specific information printed on them, or they may be blank sheets that have all necessary information printed on-demand.

The computers that can be employed in the present process are not critical as long as they perform the desired functions. The production management and control computers and software must be capable of connecting to and communicating with the following devices via a computer data network: HP Indigo press, card personalization machines, bar code reader computers, carrier printers, report printers, and computer data servers. In the best mode, this system is based on the Microsoft Windows 2000 operating system. Further, in the best mode, the network and devices are based on the following system standards: The computer data network is based on TCP/IP and Ethernet; the card personalization machines are Datacard machines running the OS/2 or Microsoft Windows operating system; the bar code reader computers are based on the Microsoft Windows operating system; the carrier printers are high-speed black and white or color laser printers; the report printers are black and white desktop laser printers; the computer data servers are dual processor computers running the Microsoft Windows 2000 operating system and the Microsoft SQL 2000 database management system. Alternate modes may have computers using the Macintosh or Unix operating systems (Linux or other variants) or earlier versions or the Microsoft Windows operating system, networks using token ring or AppleTalk standards, and inkjet or impact printers for carrier printing and report printing. The computers used for creating the master templates should be compatible with the Macintosh OS X operating system and be able to run current versions of Quark Express and HP Indigo Yours Truly Designer. The computers used for production control should be compatible with the Microsoft Windows 2000 operating system.

The graphics preparation computers and software must be capable of producing static images, variable fast text elements, and variable fast image elements in Indigo Job Layout (JLYT) format. In the best mode this is accomplished on a Macintosh computer running Quark Express version 4.1 or higher and HP Indigo Yours Truly Designer version 2.2 or higher. Alternatives may include other graphics development applications that are capable of producing Indigo Job Layout format files.

A key attribute of processes of the present invention is that all sheets in a batch may be different, and are based upon images that have been individually composed. Without automating this composition and assembly of images, each sheet must be laid out by skilled graphics operators, a process that may require one or more hours per sheet. The benefits of automated image composition and assembly are both economic and logistic. Setup time for individual product styles becomes negligible, which eliminates minimum economic order quantities, while an order as small as a single unit of a given product becomes economically feasible. The use of computers to do this also enables the management and control of a very large number of products, unique product identity codes, sheet codes, batch codes, and production runs.

The software-based “automated layout & individual production” approach to manufacturing mass-printed products results in dollar savings as well as time savings, which can ultimately convert to dollar savings. Customers place orders for a specific quantity of products. The objective for planning production quantities is to yield no less than this quantity after the final production step.

Requests to personalize and fulfill products are received daily, normally with a 1-3 day turn-around requirement. With the present process it is easily possible to meet this turn-around time requirement. In traditional processes, production runs of laminated plastic products are normally scheduled to take place over several weeks, and result in very large volumes of finished (but not personalized) products being produced. These mass-produced products are held in storage, and are withdrawn from inventory in smaller quantities on a regular (e.g. daily) basis to be personalized and fulfilled according to demand. Various approaches have been adopted to reduce the amount of inventory held (such as smaller volume production runs, more accurate forecasting of demand, etc.) but it remains an inventory-based process.

For the most part, the present invention holds little or no inventory of finished goods. Each product order generates an individual product request that is manufactured from raw materials, personalized, and fulfilled just-in-time. The benefits of this approach to production are numerous, including elimination of: inventory storage and management costs, working capital tied up in inventory, and inventory obsolescence and destruction costs.

Thus, it can be seen that the system and process of the present invention provide unique abilities and benefits with respect to manufacturing discrete printed laminated plastic products, such as credit cards and the like. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What I claim is:

1. A method of manufacturing discrete printed laminated plastic products from sheet stock comprising:
A. Providing a programmed computer,
B. Creating a master template that defines the position and other attributes of the graphics and/or text to be printed on the plastic products, all of which conform to a common specification of dimension and material composition and provides the functionality of the discrete plastic product,
C. Inputting into the computer database information concerning the type of product, information to be printed, and the information concerning the master template,
D. Providing sheet stock from which the plastic products are to be made and printing graphics and/or text in discrete areas of the sheet stock,
E. Assigning a unique identity to each discrete printed area and to each sheet containing a plurality of discrete areas, to discern that identity from identification marks integrated into each discrete area,
F. Manufacturing the laminated plastic products by laminating said sheet stock to form a laminated plastic stock material having discrete printed areas and cutting and/or punching said laminated plastic stock material to form discrete plastic products from said discrete printed areas,
G. Finishing and/or personalizing said discrete plastic products to enable them for their intended functional purpose and/or provide them with an individual identity,
H. Inspecting said discrete plastic products to determine if they meet the manufacturing standard and eliminating those that do not meet the standard,
I. Inputting the inspection results into the database of said programmed computer,
J. Re-ordering and re-manufacturing any rejected discrete printed laminated plastic products, if necessary, and finishing and/or personalizing said re-manufactured plastic products, if necessary, and
K. Collecting said discrete printed laminated functional plastic products.

2. The method of claim 1 where in said plastic products first finished and then personalized.

3. The method of claim 1 wherein the sheet material is used to make fronts and backs of the plastic products and they are subsequently joined together and laminated to form the plastic products.

4. The method of claim 1 further including the step of collating said plastic products with mailing materials for mailing to customers.

5. The method of claim 1 further including the step of collating said plastic products with mailing materials for mailing to customers wherein said plastic products are merged with mailing carriers for mailing to customers.

6. The method of claim 1 further including the step of collating said plastic products with mailing materials for mailing to customers wherein said plastic products are merged with mailing carriers and inserts for mailing to customers.

7. The method of claim 1 wherein said finishing step for said plastic products is selected from the group consisting of applying a hologram, applying a signature panel, applying a magnetic strip, applying an embedded computer chip, embossing characters on the product, engraving characters into the product, initializing the embedded computer chip, and adding an activation label, or combinations thereof.

8. The method of claim 1 wherein said personalization step for said plastic products comprises applying customer specific information to said plastic product by encoding a magnetic stripe, encoding a smart chip, embossing characters on the product, engraving characters into the product, initializing an embedded computer chip, adding an activation label, embossing an account number, embossing a valid date(s), embossing a cardholder name, embossing security symbols, indent printing of an account number, indent printing PIN information, printing personal information, printing variable text on the card face, printing graphics on the card face, and combinations thereof.

9. The method of claim 1 wherein said plastic products are made from continuous sheets of material.

10. The method of claim 1 wherein said plastic products are made from cut sheets of material.

11. The method of claim 1 wherein there are at least two layers of sheet stock which are laminated together.

12. The method of claim 1 wherein a protective layer is laminated on said sheet stock.

13. The method of claim 1 wherein an identification code is provided for each discrete area and on each sheet stock.

14. The method of claim 1 wherein an identification code is printed on each discrete area and on each sheet stock and said code is a human-readable code or machine-readable code.

15. The method of claim 1 further including the step of scanning the re-ordered products to facilitate the collation of the re-ordered products and the products that have passed inspection.

16. The method of claim 1 wherein the information from the inspection is used to coordinate or cease further manufacturing steps.

17. The method of claim 1 wherein the functional products are selected from the group consisting of credit cards, debit cards, ATM cards, shopping cards, loyalty cards, gift cards, purchase tracking cards, pre-paid cards, security cards, identification cards, keepsake cards, collection cards, telephone cards, transit passes, traveling cards, personal identification cards, personal bookmarks, cards having functional means selected from holograms, signature panels or pads, stickers, punch-out areas, magnetic strips, photographic identification strips, contact chips, contactless chips, card company identifier(s), means for identification, validation, and/or authentication, and combinations thereof.

18. The method of claim 1 wherein said inspection is performed after the manufacturing step.

19. The method of claim 1 wherein said inspection is performed after the manufacturing, functionalizing, and personalization steps.

20. The method of claim 1 wherein said inspection is performed after printing said sheet stock, after laminating said sheet stock, after die-cutting said plastic products, after finishing said plastic products, after personalization of said plastic products, after merging and inserting said plastic products during mailing, when said plastic products are collated with mailing materials for mailing to customers.

21. The method of claim 1 wherein the sheet material is used to make fronts and backs of the plastic products and they are subsequently joined together and laminated to form the plastic products and said inputted information is used to collate the joining of the fronts and backs of the plastic products.

22. The method of claim 1 further including the step of collating the re-ordered products with any additional manufacturing, finishing, and/or personalization steps.

23. A system for manufacturing discrete printed laminated functional plastic products from sheet stock comprising:
A. A programmed computer which provides a master template that defines the position and other attributes of the graphics and/or text to be printed on the plastic products,
B. Programming the computer with the information concerning the type of product, information to be printed, and entering the information concerning the master template into the computer,
C. Means for assigning a unique identity to each discrete printed area and to each sheet containing a plurality of discrete areas,
D. Means for manufacturing the laminated plastic products by feeding sheet stock, printing graphics and/or text in discrete areas of the sheet stock, laminating said sheet stock to form a laminated plastic stock material having discrete printed areas, and cutting and/or punching said laminated plastic stock material to form discrete plastic products from said discrete printed areas,
E. Means for inputting the inspection results into the database of said computer,
F. Means for finishing said discrete plastic products to enable them for their functional purpose and/or personalizing said discrete plastic products for providing them with an individual identity,
G. Means for inspecting said discrete plastic products and eliminating those that do not meet a certain standard,
H. Means for reordering the manufacture of any rejected discrete printed plastic products,
I. Means for re-ordering and manufacturing any rejected discrete printed laminated plastic products, if necessary, and
J. Means for collecting said discrete printed laminated functional plastic products.
K. Means for collating said plastic products with mailing materials for mailing to customers.

24. The system of claim 23 further including scanning means for scanning the code.

25. The system of claim 23 further including scanning means for scanning the codes and inputting the information scanned whereby the collation is facilitated.

26. The system of claim 23 wherein the functional products are selected from the group consisting of credit cards, debit cards, ATM cards, shopping cards, loyalty cards, gift cards, purchase tracking cards, pre-paid cards, security cards, identification cards, keepsake cards, collection cards, personalized bookmarks, telephone cards, transit passes, traveling cards, personal identification cards, cards having functional means selected from holograms, signature panels or pads, stickers, punch-out areas, magnetic strips, photographic identification strips, contact chips, contactless chips, card company identifier(s), means for identification, validation, and/or authentication, and combinations thereof.

27. The system of claim 23 further including means for collating said plastic products with mailing materials for mailing to customers.

28. The system of claim 23 wherein said means for finishing said plastic products is selected from the group consisting of means for applying a hologram, means for applying a signature panel, means for applying a magnetic strip, means for applying an embedded computer chip, means for embossing characters on the product, means for engraving characters into the product, means for initializing the embedded computer chip, means for adding an activation label, or combinations thereof.

29. The system of claim 23 wherein said means for personalizing said plastic products comprises means for applying customer specific information to said plastic product by encoding a magnetic stripe, initializing and/or encoding a smart chip, embossing characters on the product, embossing an account number, embossing a valid dates, embossing a cardholder name, embossing security symbols, engraving characters into the product, indent printing of an account number, indent printing PIN information, printing variable text on the card face, printing graphics on the card face, and combinations thereof.

30. The system of claim 23 further including means for merging said plastic products with carriers for holding and mailing said plastic products.

31. The system of claim 23 further including means for merging said plastic products with carriers for holding and mailing said plastic products and with inserts which are included in the mailing.
